(19) United States
(12) Patent Application Publication
(10) Pub. No.: US 2012/0086578 A1
(43) Pub. Date: Apr. 12, 2012

(54) SYSTEMS AND METHODS FOR PROVIDING NOTIFICATIONS REGARDING STATUS OF HANDHELD COMMUNICATION DEVICE

(76) Inventors: Allen J. Moss, Phoenix, AZ (US); Lucius L. Lockwood, Phoenix, AZ (US)

(21) Appl. No.: 13/269,540

(22) Filed: Oct. 7, 2011

Related U.S. Application Data
(60) Provisional application No. 61/391,032, filed on Oct. 7, 2010.

(51) Int. Cl. G08B 21/00

(52) U.S. Cl. 340/635

(57) ABSTRACT

Systems and methods of the present invention include, among other things, a system, comprising a handheld communication device and a receiver for carrying with a user of the handheld communication device to report to the user when the handheld communication device receives an incoming communication.

### CROSS REFERENCE TO RELATED APPLICATIONS

This application is related to and claims priority from U.S. Provisional Appl. No. 61/391,032, filed on Oct. 7, 2010, the content of which is hereby incorporated herein by reference.

### BACKGROUND OF THE INVENTION

1. Field of the Invention

The present invention relates to communication systems, and more particularly, to systems and methods for providing notifications regarding status of handheld communication devices.

2. Description of the Related Art

With the continued improvement in the quality of communication devices, such as handheld telephones, and the expansion in access to such devices today, it is becoming more common for people to abandon their traditional (land line) home telephone systems. Cancelling a home telephone system saves the user from having to pay for both a traditional landline telephone system, as well as a cell-phone system. And, as long as their mobile communication device provides suitable coverage, the cost savings from cancelling the home phone line is typically desirable. More and more people are doing exactly this, cancelling their home phone system, and relying on their mobile communication device for receiving telephone calls.

An issue with this growing practice is that one must keep their mobile communication device with them or in close proximity to them in order to receive notice of an incoming telephone call, email or text message. On occasion, a user will not be close enough to their communication device in order to receive notice of an incoming communication. For example, when at home, a user may connect their mobile communication device to a charger for recharging the battery, and if the user leaves the area in which the mobile communication device is being charged, the user will in most cases miss an incoming communication. When the user returns to the mobile communication device and checks to see if there any missed incoming communications, the user can listen to any missed voicemail, notice any missed calls and return the calls, see any missed emails or text messages and respond to the same. If the period of time is long for which the user is unable to receive notice from the mobile communication device of an incoming communication, a user may miss a time-sensitive communication. It would therefore be desirable to have systems and methods in place that enable a user to receive notice of incoming communications for his mobile communication device when the device is out of range for the user to otherwise receive such notice.

Thus, a need exists for systems and methods, which overcomes these and other problems.

### SUMMARY OF THE INVENTION

In accordance with embodiments of the present invention, systems and related methods are disclosed comprising a handheld communication device and a receiver for carrying with a user of the handheld communication device to report to the user when the handheld communication device receives an incoming communication.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a simplified system diagram, in accordance with systems and methods consistent with the present invention.

FIG. 2 is a simplified flow chart, in accordance with systems and methods consistent with the present invention.

### DESCRIPTION OF THE EMBODIMENTS

Reference will now be made in detail to the present exemplary embodiments of the invention, examples of which are illustrated in the accompanying drawings.

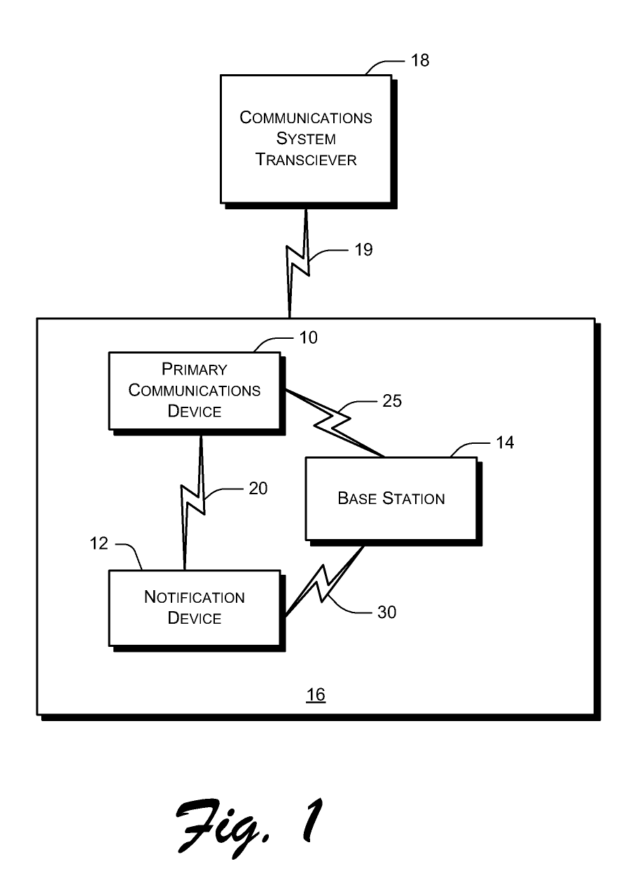

FIG. 1 below is a diagram of a simplified system that may be employed with embodiments of the present invention. System 16 may include a communication device 10 and a notification device 12. System 16 may also include a base station 14.

Communication device 10 may comprise any communication device, such as a mobile phone, a cellular phone, an electronic book reader, a pager, or a satellite phone. Communication device 10 may include functionality beyond that of a phone system, as is common today. For example, communication device 10 may comprise, essentially, a mobile computer having internet access and being capable of, among other things, receiving email, SMS text message, or any other form of communication.

Transceiver 18 may provide access to a network over which communication device 10 may receive any incoming communication or send any outgoing communication. Such incoming or outgoing communications may comprise voice, email, SMS text or any other form of communication. Transceiver 18 communicates 19 with one or more components of the system 16, and in one common scenario, transceiver may be a cellular system tower in communication with communication device 10 which in one embodiment comprises a mobile phone, although in alternative embodiments any component in system 16 could be configured to communicate with the transceiver 18. Transceiver 18 may be located on or above land, such as a transceiver in a tower on land or a transceiver in a satellite in the sky. For that matter transceiver 18 may be located anywhere, even below land. Transceiver 18 is shown as a single location, though transceiver 18 may be thought of as representing any one or more transmission points in a communication network, whether such network comprises assets on, below or above land, as is the case in conventional communication networks today.

At a minimum, system 16 may include (1) communication device 10 and notification device 12, (2) communication device 10 and base station 14 or (3) communication device 10, notification device 12 and base station 14. Notification device 12 may comprise any device for carrying by the user or accompanying the user and notifying the user of any incoming communication on communication device 10.

In one embodiment, notification device 12 is typically not a fully-complemented communication device 10, though it could be. Preferably, notification device 12 includes at least (1) a receiver for receiving notice of an incoming communication for communication device 10, (2) one or more notification systems for notifying the user of the incoming communication for communication device 10 and (3) a power supply, which is preferably rechargeable. Such notification systems may be audible, visual, or indeed, any scheme that may indicate to a user that communication device 10 is receiving an incoming communication. In various embodiments, notification systems may include any audio, visual, or tactile alert mechanisms such as lights such as LEDs whether blinking or lit, display panels, vibrators/agitators and any other mechanism capable of interacting with a person in proximity of the notification device. The notification system may notify the user of more than the fact that there is an incoming communication for communication device 10. For example, the notification system may indicate the type of incoming communication (e.g., voice call, email, SMS text or otherwise), the identify of the sender of the incoming communication, an indication of the importance of the incoming communication (e.g., routine communication, urgent communication, etc.), the subject of the incoming communication, the time of receipt of the incoming communication, whether the incoming communication is undesired (e.g., a spam email, a call from a blocked caller, etc.), a digest or condensed version of the incoming communication, or any other information about the incoming communication that a user may want learn without having to access or retrieve the communication device 10, instead opting to receive notice of same from notification device 12 and/or base station 14.

Although, as specified above, notification device 12 is typically not a fully-complemented communication device 10, it could be. Alternatively, notification device 12 may include the minimum components, as set forth above, and include some additional functionality, which is short of a fully-complemented communication device 10. For example, notification device 12 may include memory for storing media content for playback, such as audio or visual depictions such as music, video, etc. The notification device 12 may include a user interface to allow the user of the notification device 12 to customize its performance based on any desired condition. For example, the notification device 12 may include a user interface device such as a button that allows notifications to be suppressed, for example, when the user does not want to be disturbed (such as attending a quiet theatre performance, for example), or to change the output mode of the notifications (visual, audio, vibrate, a combination thereof, or various amplitudes, volumes or message styles thereof). The notification device may include an interface to allow the user to specify a filter condition to allow, suppress or forward notices of communications, and/or to indicate that messages should be referred to another person.

While in a preferred embodiment notification device 12 includes a receiver for receiving the notification message indicating the incoming communication, the notification device 12 may include a bidirectional communications component such as a transceiver to communicate with one or more of the communications device 10, the base station 14 or the transceiver 18. In embodiments employing the bidirectional interface, the notification device 12 could send a control message to either the communications device 10 or the base station 14 (or a combination thereof) to control the mode, method, or content of notifications. For example, a control message could be sent by the notification device 12 to the communication device 10 indicating that a predetermined or prerecorded response should be sent to the originating party (such as the user is unavailable at the present time, and that the user's assistant should be contacted at a provided contact number or address). Alternatively, the user could actuate a button or other input mechanism on the notification device 12 to send to the communication device 10 and/or base station 14 a simple, yes/no/acknowledged confirmation that is to be sent to the originator of the incoming communication message. In yet another embodiment, a microphone and/or camera included in the notification device 12 may record a message or other response from the user for forwarding to the originator of the incoming message. In one implementation, the user may dictate a message to notification device 12 which is converted by conventional speech to text algorithms to a text message, and sent to the originator of the incoming message.

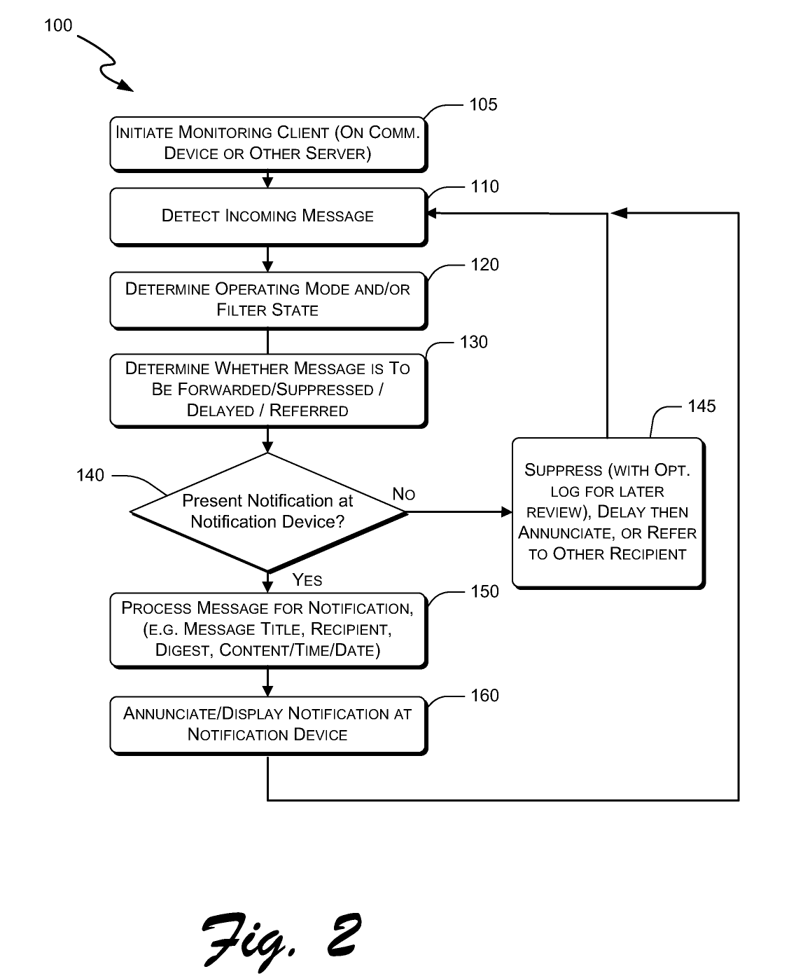

Referring to FIG. 2, a flow diagram 100 illustrates one embodiment of a method of the present invention. As an initial step 105, a monitoring client is initialized to begin monitoring incoming communications. In a preferred embodiment, the monitoring client is a software program running on the communications device 10, but may be installed and running in a base station 14 in place of or in combination with the installation on the communications device 10. Alternatively, the notification device 12 may contain such a monitoring client, wherein the notification device 12 monitors the communications 19 to the system 16 and performs all necessary computation to determine that an incoming communication was being sent to the communication device 10, and may further analyze the incoming communication message to present any desired information to the user.

The process continues with an incoming message being detected 110, whereupon 120 a filter state may be examined to determine what processing is to be done as a result of a monitoring state, the message content, and any relevant context. In a primary embodiment, every message is simply passed on for notification processing and annunciation from the notification device 12, and no filtering occurs. However, in alternate embodiments the user may specify a desired monitoring state or mode through input to the notification device 12, a base station 14, or the communication device 10. Such desired monitoring states or modes may include an off/quiescent mode, a Do Not Disturb mode, a mode where notifications for all incoming communications are received, a mode where only messages identified as having high importance (by message content or any user- or system-specified predetermined criteria) are to be announced by the monitoring device 12, a mode where incoming messages originating from sources stored within the user's pre-stored contact list are to be announced, a mode where only incoming messages from a certain specified sender are to be announced, or any other desired mode of monitoring. Further, the user may specify a shortcut mode of operation that customizes filtering accordingly, for instance, a “home” mode, a “theatre” mode, a “driving” mode, a “work” mode, or any other desired mode that influences, in a predetermined manner, which incoming messages result in notification being provided by the notification device 12 to the user. In addition, filtering modes or monitoring states may be contextually deduced by any device of the system 16, such as if the communication device 10 determines that it is within a predetermined proximity of or otherwise connected to the base station 14, monitoring mode is set to a predetermined mode such as “home” condition. Likewise, if any component of the system 16 determines that the notification device 12 is in motion within a certain velocity range, the filtering mode or monitoring state may be set to a “driving” condition.

Based upon the determination 120 of the mode/state of the notification system 16, a determination is then made 130 as to how the notification of the incoming message is to be processed. For example, the determination is made whether notification of the incoming message is to be forwarded to and annunciated at the notification device 12, suppressed and not forwarded (with an optional log of suppressed messages being saved for later review by the user at any place such as on the notification device 12), delayed and then annunciated at the notification device 12 (such as if the user does not want to be disturbed for a predetermined period of time) or referred to another communication or notification device (such as may be the case if the user would like the notification forwarded to a family member, work colleague, or assistant). If notification is to be annunciated 140 at the notification device 12, then the incoming communication is processed 150 to produce the desired output at the notification device 12 and/or base station 14. For example, the message originator could be extracted from the message and specified for display on the notification device 12, or a digest or any other subset of the incoming communication may be annunciated at the notification device 12. Finally, the notification message is annunciated, displayed or presented in any desired manner 160 at the notification device 12. If the notification is not to be annunciated or displayed, then appropriate processing occurs as described above and as shown in step 145. In either case, monitoring continues 105 until terminated by the user or other condition. Any of the functionality described above in regards to FIG. 2 may also be carried out entirely or partially within the base station 14, and in some embodiments, the base station provides the annunciation, display or other notifications that are preformed by the notification device 12.

Notification device 12 preferably comprises a device that a user can bring anywhere with great ease, meaning notification device 12 may be carried, worn, or may otherwise accompany the user. For example, notification device 12 may comprise any structure that may be attached to or incorporated with anything that may accompany a user. For example, notification device 12 may comprise any structure that may be attached to or incorporated with an article of clothing, such as a hat, a headband, a shirt, a pair of pants, a scarf, a coat, a tie, a dress, a blouse, a shoe, a sock, an undergarment, etc. Alternatively, notification device 12 may comprise any structure that may be attached to or incorporated with a piece of jewelry or any other structure that a user may wear, such as a wristband, a necklace, an arm bracelet, an ankle bracelet, a headband, a ring, an earring, a piercing stud or other piercing structure, etc. In another embodiment, notification device 12 may be included in eyeglasses and/or shades, and in one implementation, visual indicia may be presented by the eyeglasses and/or shades and may be viewable by the user. Such visual indicia may include either a simple visual indication that a message is available (such as a blinking light, or optionally a colored blinking light with various colors corresponding to different priorities) or a more detailed display such as text or video that is visible and readable by the user wearing the eyeglasses and/or shades. In yet another embodiment, the eyeglasses and/or shades include an audio output device that can provide an audio annunciation of the incoming message notification in proximity to the user's ear. Other embodiments of the notification device 12 may be included within a user's car key, home key, or automobile electronics, or a user's pedometer, dog leash, shoes, or workout assistance device. Simply put, notification device 12 may comprise any structure that may be attached to or incorporated with anything that may accompany a user, whether the user carries the device 12 or the device is attached to or incorporated with anything that may accompany a user. Notification device may comprise a component of the base station 14, so that if user interfaces the communication device 10 with the base station 14, the user may take a portable component from the base station 14, which is then enabled to provide notifications and acts as the notification device 12 (such may be the case, for instance if the user docks a communication device 10 with a base station 14 to charge the communication device's battery). In an alternative embodiment, notification device 12 may also comprise any structure that may be implanted into or attached to the user.

System 16 may also include a base station 14. Base station 14 may be used to supplement notification device 12 or in lieu of notification device 12. Base station 14 gives the user the flexibility of not having to carry or have notification device 12 accompany user, for example when notification device 12 is being recharged, while still retaining the capability of receiving notice of incoming communication for communication device 10 over base station 14. A user could utilize as many base stations 14, as desired, to provide the desired coverage, and base stations 14 may be in networked communication such as by a Zigbee protocol or 802.11 wireless network protocol. For example, if a user lived in a small space, one base station 14 may provide suitable notice to a user of incoming communications for communication device 10, regardless of where the user was within the living space. A larger living (or other, i.e., any type of space may employ one or more base stations 14) space may require more base stations 14, assuming the user opts to use base stations at all, to cover the full space.

Base station 14 is typically not a fully-complemented communication device 10, though it could be. Preferably, base station 14 includes at least (1) a receiver for receiving notice of an incoming communication for communication device 10, (2) one or more notification systems for notifying the user of the incoming communication for communication device 10 and (3) a power supply, which is preferably rechargeable. Such notification systems may be audible, visual, or indeed, any scheme that may indicate to a user that communication device 10 is receiving an incoming communication. The notification system may notify the user of more than the fact that there is an incoming communication for communication device 10. For example, the notification system may indicate the type of incoming communication (e.g., voice call, email, SMS text or otherwise), the identify of the sender of the incoming communication, an indication of the importance of the incoming communication (e.g., routine communication, urgent communication, etc.), the subject of the incoming communication, the time of receipt of the incoming communication, whether the incoming communication is undesired (e.g., a spam email, a call from a blocked caller, etc.) or any other information about the incoming communication that a user may want learn without having to retrieve the communication device 10, instead opting to receive notice of same from notification device 12 and/or base station 14.

Although, as specified above, base station 14 is typically not a fully-complemented communication device 10, it could be. Alternatively, base station 14 may include the minimum components, as set forth above, and include some additional functionality, which is short of a fully-complemented communication device 10. For example, base station 14 may include memory for storing media content for playback, such as audio or visual depictions such as music, video, etc.

Other embodiments of the invention will be apparent to those skilled in the art from consideration of the specification and embodiments disclosed herein. Thus, the specification and examples are exemplary only, with the true scope and spirit of the invention set forth in the following claim and legal equivalents thereof.

Other embodiments of the invention will be apparent to those skilled in the art from consideration of the specification and practice of the invention disclosed herein. It is intended that the specification and examples be considered as exemplary only, with a true scope and spirit of the invention being indicated by the following claim.

What is claimed is:

1. We claim each method, apparatus, device, system, and combinations thereof as illustrated, shown, implied, and described.
